(19) United States
(12) Patent Application Publication
(10) Pub. No.: US 2006/0242350 A1
(43) Pub. Date: Oct. 26, 2006

(54) Opto-couplers for communication bus interfaces using low efficiency silicon based LEDs

(76) Inventor: Eugene Robert Worley SR., Irvine, CA (US)

Correspondence Address: EUGENE R. WORLEY, 11 BOWDITCH, IRVINE, CA, 92620, US

(21) Appl. No.: 11/409,794

(22) Filed: Apr. 22, 2006

Related U.S. Application Data
(60) Provisional application No. 60/673,579, filed on Apr. 22, 2005.

(51) Int. Cl. G06F 13/14

(52) U.S. Cl. 710/305

(57) ABSTRACT

This invention describes a means by which a communication data bus can be electrically isolated from noise generating electrical devices such as electromagnetic actuators, which are controlled by data from the bus, using a single integrated circuit package. Specifically, an all silicon optically isolated interface within the package is used to galvanic insulate the circuitry associated with the data bus interface from the circuitry operating or receiving data from devices such as motors, sensors, etc. that are connected to a noisy environment.

### RELATED APPLICATION

This Application claims the benefit of Provisional Application Ser. No. 60/673,579, filed on Apr. 22, 2005.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

This invention relates to computer communication bus interface applications using optically coupled electronic integrated circuits, and more particularly to applications in which data from a computer communication bus is electrically isolated from devices that are being controlled by the computer.

### BACKGROUND

Controller or communication buses are used to send and receive data from devices to a controlling computer. The devices can include actuators such as electric motors, relays, and solenoids, display devices, light sources, heat sources, and sensors such as, but not limited to, pressure sensors, temperature sensors, electrical current sensors, voltage sensors, and position sensors. Thus, a controlling computer can send data down the bus to, say, turn on an electric motor, or turn off a light, or to sound a buzzer, or to up date display information. Also, a controlling computer can receive data form the bus that comes from sensors. Furthermore, the controlling computer can send and receive data from a secondary computer. Communication bus standards include CAN, SAFEbus (avionics bus for aircraft), MicroLAN, I²C-bus, PROFIBUS, RS232, and RS485. For automotive applications there is FlexRay and Time-Triggered Architecture (TTA).

There can be devices that are controlled by a communication bus that generate electrical noise and electrical transient spikes such as electric motors and solenoids. For these cases an opto-coupler can be used to electrically isolate the communication bus from the noise generating device being controlled by the bus. Thus, the opto-coupler prevents noise from the noise generating device from corrupting communication bus data.

In the simplest opto-couplers there are two devices, a Light Emitting Diode (LED) and a light detector. The LED is usually made of doped GaAsP material. The LED and the light detector are separated by a transparent, insulating layer thereby allowing light to pass through but not electrical current. The detector is typically a single device such as a diode, a bipolar transistor, an SCR, or a Triac. Detector chips may also include circuits such as amplifiers and various types of output buffer/drivers. Moreover, an additional silicon chip can be added as a input buffer/driver for the LED. The input signal may be, for example, a TTL type, which can not directly drive the LED. Since the LED diver chip must be isolated from the detector chip, three separate chips are thus required in this case: the silicon LED driver chip, the GaAs based LED, and the detector chip.

Using available parts, to interface a noisy device to a communication bus typically requires several integrated circuits or chips as shown in FIG. 1. Two optically isolated data paths are shown, one in which data from the communication bus 101 is transmitted to Device 109 which can be, for example, a motor to be controlled, a solenoid, etc, and a second data path in which the communication bus 101 receives data from Device 2 110 which can be, for example, a temperature sensor, pressure transducer, etc.

For the first data path data is received from the communication bus 101. This is accomplished by the address of the Data Bus Receiver 103 first being transmitted on 101. The transmission of the Data Bus Receiver's 103 address on bus 101 tells the Data Bus Receiver 103 that data intended for it will transmitted next. The data is then fed to an LED Driver 104, which in turn controls the light output of an LED in the optocoupler 105. In the diagram of FIG. 1 a simple optocoupler is shown with an LED made of GaAsP and a bipolar photo transistor that is used as a light detector. It is noted that the optocoupler 105 is for illustration purposes and that a more complex optocoupler could have also been used. The output of the optocoupler 105 is then fed to an optocoupler receiver 106. The receiver 106 can be anything from a load resistor for the photo transistor to an amplifier. The output of the Opto Coupler Receiver 106 is then fed to a Device1 Driver 107, which in turn drives Device1 109. Device Driver1 107 could, for example, be a power switch MOSFET used to turn an electric motor, solenoid, etc. “on” and “off”.

In the reverse direction, data is generated from Device2 110. This data could include temperature data, pressure data, position data, etc. The data is then received by Device2 Receiver 111. The Device2 Receiver 111 can be an amplifier followed by an Analog to Digital (A to D) converter, for example. The Device2 Receiver 111 then sends signals to the LED Driver 112, which in turn controls the light output of the LED of the optocoupler 113, which, again by way of illustration, is a simple LED-Photo transistor type. The output of the optocoupler 113 is fed to the Opto Coupler Receiver 114 that interfaces with photo transistor's output to the Data Bus Transmitter 115. Finally, the data from Device2 110 is transmitted to the controller data bus by the Data Bus Transmitter 115. In general the Data Bus Receiver 103 and the Data Bus Transmitter 115 are on one chip. An example of a data bus transceiver that communicates with an I²C bus to provide an 8 bit I/O is the Phillips PCF8574 chip.

Sophisticated optocouplers can be realized using silicon LEDs. Silicon LEDs can be made using a PN junction in the avalanche mode (U.S. Pat. No. 6,365,951) or PN junctions in the forward mode (U.S. Pat. No. 6,710,376), especially if the junction area has damage to enhance light emission. In the avalanche mode the light emission is in the visible spectrum centered in the yellow region while in the forward biased mode it is in the infrared region.

FIG. 2 shows an example of the package construction of an all silicon opto-coupler (U.S. Pat. No. 6,393,183). FIG. 2A is the top view of the package and FIG. 2B is a cross section. The package 200 shown is a flat pack with two rows of leads, a left side 211 and a right side 212. The row of leads on the left side 211 is electrically isolated from the row of leads on the right side 212.

The cross section shows two silicon die, 205 and 206, facing each other and separated by a transparent insulator 207. Bond wire 208 goes from a package lead 202 associated with the 211 row of leads to a bond pad of die 205 and bond wire 204 goes from package lead 203 to a bond pad of die 206. The die 205 is attached to the upper lead frame base plate 210 and die 206 is attached to the lower lead frame base plate 209. The entire structure is surrounded by a plastic encapsulent 201. Light 213 is shown being transmitted from an silicon based LED 214 on die 206 to a light detector 215 on die 205. Thus, in this example, light is transmitted from one die 206 to a second die 205 that is electrically isolated from the first die 206. Signal communication is therefore made between die 205 and 206 without any electrical connection.

### SUMMARY

It is the objective of this invention to show how low efficiency, on chip silicon LEDs can be used to realize integrated circuits than can receive and transmit signals form a controller or communication bus and deliver or receive signals from a device to be controlled without any electrical connection between the bus and the device. Specifically, these integrated circuits include at least a bus interface circuit for transmitting and receiving bus data, one or more silicon LEDs, one or more silicon light detectors, one or more amplifiers for the light detector signal, one or more drivers for the LED, and device drivers and/or receivers. Depending on the application, data formatting may be required and A to D and D to A converters may also be required. Data formatting involves taking data from a device or plurality of devices and streaming the data through the optocoupler or, conversely, receiving data streams from the optocoupler and reformatting it for a device or a plurality of devices.

### BRIEF DESCRIPTION OF THE DRAWINGS

FIG. 1. shows a block diagram of a optically isolated communication bus to device circuit that can transmit and receive signals from devices and is made up of several discrete, off the shelf integrated circuits.

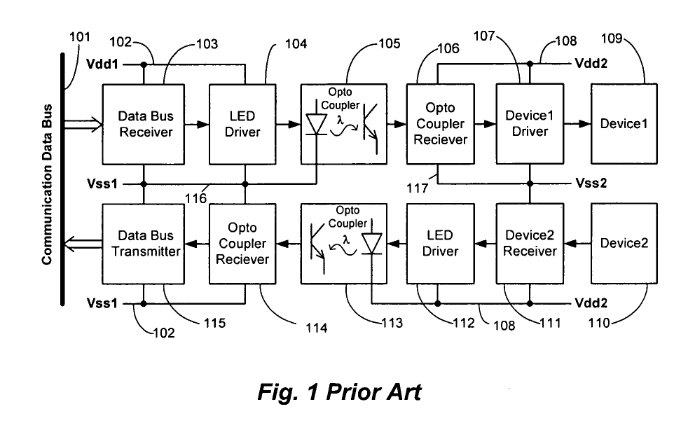

FIG. 2 shows a prior art to view and cross section of an all silicon opto-coupler package with a silicon LED

FIG. 3 shows a single package, optically isolated, communications bus to device integrated circuit comprised of two integrated circuits with integrated silicon LEDs.

FIG. 4 shows a device side integrated circuits than can control a plurality of devices and can receive data from a plurality of devices.

### DESCRIPTION OF THE PREFERRED EMBODIMENT

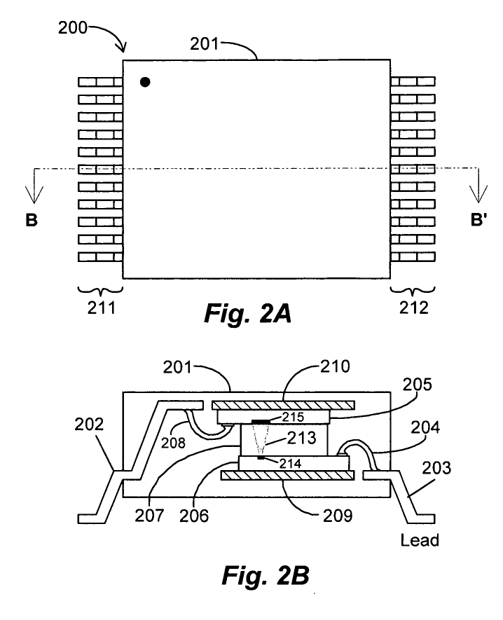

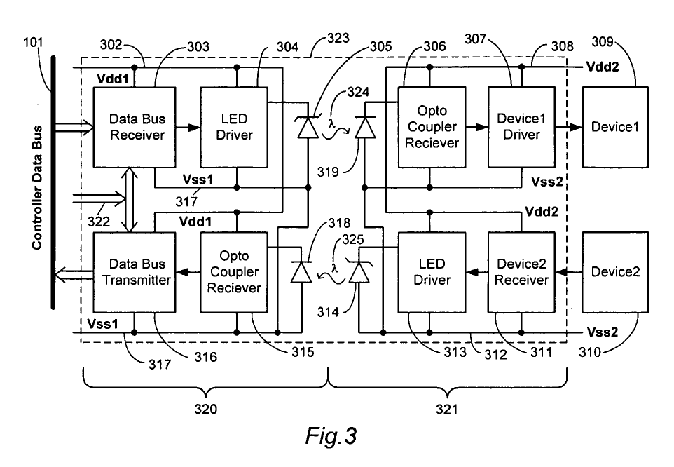

FIG. 3 shows an example of an optically isolated bus interface circuit, which is able to transmit and receive data from a communication bus 101 and send the control information inherent in the bus data to a device 309 or send information from a device 310 to the bus 101. Two integrated circuits or chips, 320 and 321, which are placed in a single package 323 as depicted in FIG. 2, are required to perform the aforementioned functions. Chip 320 is associated with electrical circuit side that deals with direct bus communications while chip 321 is associated with the electrical circuit side that deals with the device to be controlled. Thus, chip 320 will be referred to as the bus communication side chip and chip 321 as the device side chip. Data transfer between the two isolated electrical circuit sides is accomplished with pairs of integrated silicon LEDs and light detectors. The silicon LEDs are integrated onto the silicon substrate and may be fabricated by any number of means such as porous silicon, avalanching silicon PN junction, or forward biased silicon PN junction. Furthermore, these applications can be realized using low efficiency, silicon based LEDs. Chip 320 can correspond to either chip 205 or 206 of FIG. 2 while chip 321 corresponds to the opposite chip. Note that light can be both transmitted and received by the same chip by simply locating the LED and light detector well away from each other so that there is no interaction.

For the receive path from the communication bus 101 to Device1 309 there is the Data Bus Receiver 303 which extracts input data from the bus 101. To identify data that is to be transmitted to the Data Bus Receiver 303 address information is first transmitted on the bus 101. When there is a match between the address transmitted on the bus 101 and the address 322 input to the Data Bus Receiver 303 the Data Bus Receiver 303 is then put into the receive mode and begins to receive subsequent data from bus 101. The bus address 322 can come from an external source as shown in FIG. 3 which can include hard wired address pins, or from a hard wire connection internal to the chip with no address pin leads passing outside the chip. Other possible address sources include poly silicon fuses internal to chip 320 that are blown according to a desired bus address or an EPROM internal to chip 320 that can be reprogrammed from the data bus input pins.

Data from the data bus 101 targeted for part 323 is collected by the Data Bus Receiver 303 and then formatted for transmission serially to the device chip 321. Thus, the Data Bus Receiver 303 can buffer data that comes from the bus 101 at a rate faster than can be transmitted via the optical data link comprising LED 305 and photo detector 319. Therefore, the data is converted by LED 305 into light 324 pulses that are received by photo detector 319, which, in turn, converts the light 324 pulses back into electrical pulses. The electrical pulses produced by the photo detector 319 mirror the serial data stream input to the LED 305. The Opto Coupler Receiver 306 amplifies the photo detector signal and generates logic level signals. The Device1 Driver 307 accepts the data from the Opto Coupler Receiver 306 and uses it to control Device1 309.

In the reverse direction data from Device2 310 can be sent to the Communications Bus 101. The reverse direction data transfer begins by electrical data from Device2 310 being sent to the Device2 Receiver 311 of chip 321. The data can be buffered, as an option, by the Device2 Receiver 311 if the optical transmission rate is lower than the data generation rate. The data from the Device2 Receiver 311 then drives the LED 314 with electrical pulses corresponding to the data originally input from Device2 310. Light 325 pulses from LED 314 is then received by photo detector 318 and converted back into electrical pulses. The electrical pulses from photo detector 318 are amplified by the Opto Coupler Receiver 315 and sent as logical data pulses to the Data Bus Transmitter 316. The Data Bus Transmitter 316 can, as an option, buffer the data such that data can be collected over time from the optical link comprising LED 314 and photo detector 318 and then transmitted in a burst mode out onto the Communications Bus 101 via the Data Bus Transmitter 316.

Power for the chip 320 associated with the data bus side is supplied by Vdd1 302 and Vss1 317 and power for the chip 321 associated with the device side is supplied by Vdd2 308 and Vss2 312.

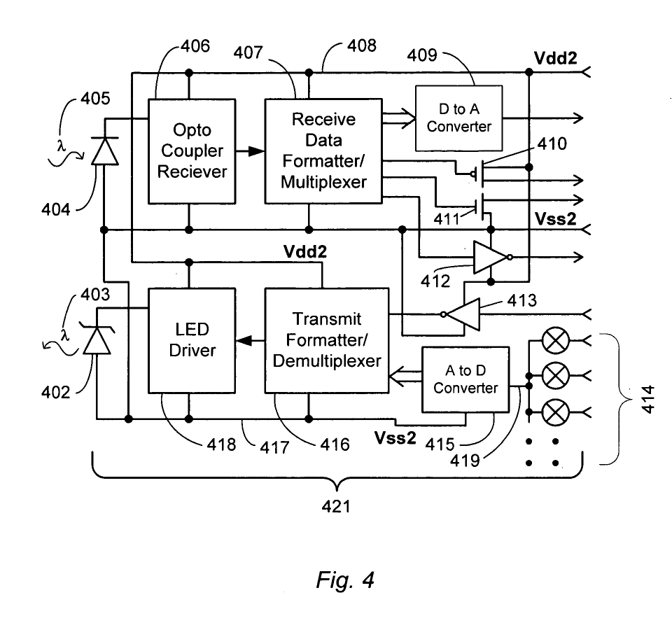

FIG. 4 shows how the device side chip that can be architected to control and receive data from many different devices. The device side chip 421 corresponds to the device side chip 321 of FIG. 3 but includes a plurality of device ports for controlling a plurality of devices and receiving data from a plurality of sensors. As in FIG. 3, a photo detector 404 receives light 405 from an LED located on the data bus chip side such as integrated circuit 320 of FIG. 3. The data stream is received by the Opto Coupler Receiver 406 where the photo detector signal is amplified and converted into a digital data signal. This data signal is then sent to the Receive Data Formatter/Multiplexer 407 where the data formatted for a plurality of output devices. The Receive Data Formatter/Multiplexer 407 then outputs the data to the appropriate devices. As examples, but not limited to, are a D to A converter 409 which can output a voltage or current in response to digital data, an NFET power switch 411 to ground or Vss2, a PFET power switch 410 to Vdd2, and an inverter 412 that can output a digital signal.

A plurality of devices can also input data to integrated circuit 421. As an example, but not limited to, are an inverter 413 than can receive a digital signal, and an A to D converter 415 which is shown with multiplexed analog inputs. The input multiplexer 414 is used to sample analog signals from a plurality of sources. Alternatively, if only one analog signal is to be received or it is required that the analog signal be sampled frequently then package pin input can be directly connected to the input 419 of the A to D converter 415, or for a plurality of inputs requiring frequent sampling, a plurality of A to D converters. Control of the analog multiplexer 414 comes from digital signals output from the Receive Data Formatter/Multiplexer 407.

Data from a plurality of devices such as, but not limited to, inverter 413 and A to D converter 415, are received by the Transmit Data Formatter/Demultiplexer 416. The Transmit Data Formatter/Demultiplexer 416 takes the data from a plurality of devices and formats the data for serial transmission through the optical link comprising LED 402 and a photo detector not shown but similar to 318 of FIG. 3. LED Driver 418 takes the digital data stream and uses it to pulse the LED 402 according the digital data stream. Light 403 is then emitted from LED 402 for reception by the photo detector on the communication bus side integrated circuit such as 320 of FIG. 3.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. An optically isolated bus interface, comprising:
a first chip comprising,
an integrated data bus receiver; and
an integrated silicon LED coupled to the data bus receiver;
a second chip comprising,
a integrated photo detector; and
an integrated device driver coupled to the photo detector; and
a transparent insulator disposed between the first and second chips, wherein the photo detector and the silicon LED form an optical link between the first and second chips through the transparent insulator.

2. The optically isolated bus interface of claim 1, further comprising an address associated with the data bus receiver, wherein the data bus receiver goes into a receive mode when an address received by the data bus receiver matches the address associated with the data bus receiver.

3. The optically isolated bus interface of claim 1, wherein the data bus receiver buffers data received by the data bus receiver, and transmits the buffered data to the device driver via the optical link.

4. The optically isolated bus interface of claim 3, wherein the data bus receiver formats the buffered data for serial transmission to the device driver via the optical link.

5. The optically isolated bus interface of claim 1, wherein the device driver is configured to drive a motor.

6. The optically isolated bus interface of claim 1, wherein the device driver is configured to drive a solenoid.

7. The optically isolated bus interface of claim 1, wherein the first and second chips are packaged together in a single package.

8. An optically isolated bus interface, comprising:
a first chip comprising,
an integrated data bus transmitter; and
an integrated photo detector coupled to the data bus transmitter;
a second chip comprising,
an integrated silicon LED; and
an integrated device receiver coupled to the LED; and
a transparent insulator disposed between the first and second chips, wherein the photo detector and the silicon LED form an optical link between the first and second chips through the transparent insulator.

9. The optically isolated bus interface of claim 8, wherein the device receiver is configured to receive data from a temperature sensor, and transmit the received data to the data bus transmitter via the optical link.

10. The optically isolated bus interface of claim 8, wherein the device receiver is configured to receive data from a pressure transducer, and transmit the received data to the data bus transmitter via the optical link.

11. The optically isolated bus interface of claim 8, wherein the device receiver buffers data received by the device receiver, and transmits the buffered data to the data bus transmitter via the optical link.

12. The optically isolated bus interface of claim 11, wherein the data bus transmitter buffers data received from the device receiver, and transmits the buffered data in a burst mode over a bus.

13. The optically isolated bus interface of claim 8, wherein the first and second chips are packaged together in a single package.

14. An optically isolated bus interface, comprising:
a first chip comprising,
an integrated data bus receiver; and
an integrated silicon LED coupled to the data bus receiver;
a second chip comprising,
a integrated photo detector; and
an integrated multiplexer coupled to the photo detector, wherein the multiplexer comprises a plurality of outputs configured to be coupled to devices; and
a transparent insulator disposed between the first and second chips, wherein the photo detector and the silicon LED form an optical link between the first and second chips through the transparent insulator, and the multiplexer formats and routes data received from the data bus receiver via the optical link to one of the plurality of outputs.

15. The optically isolated bus interface of claim 14, further comprising an address associated with the data bus receiver, wherein the data bus receiver goes into a receive mode when an address received by the data bus receiver matches the address associated with the data bus receiver.

16. The optically isolated bus interface of claim 14, wherein the data bus receiver buffers data received by the data bus receiver, and transmits the buffered data to the multiplexer via the optical link.

17. The optically isolated bus interface of claim 16, wherein the data bus receiver formats the buffered data for serial transmission to the multiplexer via the optical link.

18. The optically isolated bus interface of claim 14, wherein the first and second chips are packaged together in a single package.
